(19) United States
(12) Patent Application Publication
(10) Pub. No.: US 2002/0110312 A1
(43) Pub. Date: Aug. 15, 2002

(54) Integrated mirror array and circuit device with improved electrode configuration

(75) Inventors: Xiao Yang, Fremont, CA (US); Dale A. Gee, Los Gatos, CA (US); Anup K. Nayak, Fremont, CA (US)

Correspondence Address: Richard T. Ogawa, TOWNSEND and TOWNSEND and CREW LLP, Two Embarcadero Center, 8th Floor, San Francisco, CA, 94111-3834, US

(73) Assignee: Nayna Networks, Inc.

(21) Appl. No.: 09/771,296

(22) Filed: Jan. 25, 2001

Related U.S. Application Data
(60) Provisional application No. 60/219,798, filed on Jul. 20, 2000.

(51) Int. Cl. G02B 6/35; G02B 6/12; G02B 6/28

(52) U.S. Cl. 385/18; 385/14; 385/24

(57) ABSTRACT

An integrated circuit and mirror device and method. The device has a first substrate comprising a plurality of electrode groups, which comprise a plurality of electrodes. The device also has a mirror array formed on a second substrate. Each of the mirrors on the array has a mirror surface being able to pivot about a point in space. Each of the mirrors has a backside surface operably coupled to one of the electrode groups. The device has a capacitance spacer layer disposed between each of the electrode groups and its respective mirror. The mirror is one from the mirror array. A drive circuitry is coupled to each electrode groups. The drive circuitry is configured to apply a drive voltage to any one of the electrodes in each of the electrode groups. The drive circuitry is also disposed in the first substrate and is adapted to pivot each of the mirror faces about the point in space.

### CROSS-REFERENCE TO RELATED APPLICATIONS

This application claims priority to U.S. Provisional Application Serial No. ______ (Docket No.: 20479-000900US), commonly assigned, and hereby incorporated herein by reference for all purposes.

This application is also being filed concurrently with U.S. Serial Nos. ______ (Docket No.: 20479-000910US) and ______ (Docket No.: 20479-000920US), each of which is commonly assigned and hereby incorporated herein by reference for all purposes.

### BACKGROUND OF THE INVENTION

This invention generally relates to techniques for optical switching. More particularly, the present invention provides a device and method having a novel mirror configuration. Merely by way of example, the present invention is implemented using such device in a wide area network for long haul telecommunications, but it would be recognized that the invention has a much broader range of applicability. The invention can be applied to other types of networks including local area networks, enterprise networks, and the like.

Digital telephone has progressed with the need for faster communication networks. Conventionally, standard analog voice telephone signals have been converted into digital signals. These signals can be 64,000 bits/second and greater in some applications. Other telephone circuits interleave these bit streams from 24 digitized phone lines into a single sequence of 1.5 Mbit/second, commonly called the T1 or DS1 rate. The T1 rate feeds into higher rates such as T2 and T3. A T4 may also be used. Single mode fiber optics have also been used at much higher speeds of data transfer. Here, optical switching networks have also been improved. An example of such optical switching standard is called the Synchronous Optical Network (SONET), which is a switching standard designed for telecommunications to use transmission capacity more efficiently than the conventional digital telephone hierarchy, which was noted above. SONET organizes data into 810-byte “frames” that include data on signal routing and designation as well as the signal itself. The frames can be switched individually without breaking the signal up into its components, but still require conventional switching devices.

Most of the conventional switching devices require the need to convert optical signals from a first source into electric signals for switching such optical signals over a communication network. Once the electric signals have been switched, they are converted back into optical signals for transmission over the network. As merely an example, a product called the SN 16000, BroadLeaf™ Network Operating System (NOS), made by Sycamore Networks, Inc. uses such electrical switching technique. Numerous limitations exist with such conventional electrical switching technique. For example, such electrical switching often requires a lot of complex electronic devices, which make the device difficult to scale. Additionally, such electronic devices become prone to failure, thereby influencing reliability of the network. The switch is also slow and is only as fast as the electrical devices. Accordingly, techniques for switching optical signals using a purely optical technology have been proposed. Such technology can use a wave guide approach for switching optical signals. Unfortunately, such technology has been difficult to scale and to build commercial devices.

Other companies have also been attempting to develop technologies for switching high number of signals in other manners such as high density mirror arrays, but have been generally unsuccessful. One of the major obstacles to manufacturing high-density mirror arrays is the sheer number of interconnects that must come out of the mirrors for control and sensing. Another issue that arises is that since the mirrors are so small the capacitance values (fempto-farads) that one uses to sense the mirror position are equally as small that if one tries to sense the capacitance “off-chip” the signal is buried in the noise of the stray capacitance from the interconnects. Accordingly, such attempts have been unsuccessful.

From the above, it is seen that an improved way to switching a plurality of optical signal is highly desirable.

### SUMMARY OF THE INVENTION

According to the present invention, a technique including a device and method for optical switching is provided. More particularly, the invention provides an integrated circuit and mirror device with improved electrode features. Merely by way of example, the present invention is implemented using such a device in a wide area network for long haul telecommunications, but it would be recognized that the invention has a much broader range of applicability. The invention can be applied to other types of networks including local area networks, enterprise networks, and the like.

In a specific embodiment, the invention provides an integrated circuit and mirror device. The device has a first substrate comprising a plurality of electrode groups, which comprise a plurality of electrodes. The device also has a mirror array formed on a second substrate. Each of the mirrors on the array has a mirror surface being able to pivot about a point in space. Each of the mirrors has a backside surface operably coupled to one of the electrode groups. The device has a capacitance spacer layer disposed between each of the electrode groups and its respective mirror. The mirror is one from the mirror array. A drive circuitry is coupled to each electrode groups. The drive circuitry is configured to apply a drive voltage to any one of the electrodes in each of the electrode groups. The drive circuitry is also disposed in the first substrate and is adapted to pivot each of the mirror faces about the point in space.

In an alternative embodiment, the present invention provides an integrated circuit and mirror device. The device includes a first substrate comprising a plurality of electrode groups. Each of the groups comprises a plurality of electrodes. The device also has a mirror array formed on a second substrate. Each of the mirrors on the array has a mirror surface being able to pivot about a point in space. Each of the mirrors has a backside surface operably coupled to one of the electrode groups. A capacitance spacer layer is disposed between each of the electrode groups and its respective mirror. The mirror is one from the mirror array. The device has a drive circuitry coupled to each electrode groups. The drive circuitry is configured to apply a drive voltage to any one of the electrodes in each of the electrode groups. The drive circuitry is disposed in the first substrate and is adapted to pivot each of the mirror faces about the point in space. The device has a shielding layer (e.g., aluminum, barrier metal layer, titanium nitride) disposed between the drive circuitry and electrode groups. The shielding layer prevents a possibility of electromagnetic noise from coupling between the drive circuitry and the electrode groups.

Still further, the present invention provides a method for manufacturing an integrated mirror array and integrated circuit. The method also includes forming an integrated circuit device layer on a first substrate; and forming a dielectric layer overlying the integrated circuit device layer. The method includes forming a shielding layer overlying the dielectric layer; and forming a plurality of electrode groups overlying the shielding layer. Each of the electrode groups comprises a plurality of electrodes overlying the shielding layer. The method forms a capacitance layer overlying the plurality of electrode groups. The capacitance layer is formed at a predetermined thickness to provide a selected capacitance level; and joins a second substrate comprising the mirror array to the first substrate. Each of the mirrors on the array has a mirror surface being able to pivot about a point in space. Each of the mirrors has a backside surface operably coupled to one of the electrode groups.

In a specific embodiment, the invention provides a method for operating an actuation of a movable mirror device. The method applies a selected voltage to drive electrode coupled to a mirror device to form an increasing electrostatic force to actuate the mirror device. The mirror device supported by one or more torsion bars that allows the mirror device to move in annular manner about an axis. The axis is parallel to the one or more torsion bars. The method controls the selected voltage to the drive electrode where the mirror operates and moves in the annular manner within a pull-in range, where a mechanical force of the torsion bar(s) provides a resistance force against the increasing electrostatic force such that the mechanical force may pull or counter act the mirror device back to its steady state position by decreasing the electrostatic force. The pull-in range is dependent upon a spring constant of the torsion bar, an angular position of the mirror device, a permittivity of at least a medium between the drive electrode and the mirror device, and the selected voltage that is applied to the drive electrode.

Many benefits are achieved by way of the present invention over conventional techniques. In a specific embodiment, the invention provides an integrated solution for controlling each of the mirrors on the array using integrated circuit technology. Additionally, the invention can be made using conventional semiconductor technology. In other aspects, the invention reduces a number of possible interconnects, which interface to a controller device, e.g., computer, network switching module. The invention is easy to make and can be used to form highly integrated and large density mirror arrays, e.g., 100, 500, 1000, 5000, 10,000 and greater. The invention also has the ability to sense small variations in capacitance to sense movement of the mirrors. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is simplified diagram of an optical switching network according to an embodiment of the present invention;

FIG. 2 is a simplified diagram of an optical switching apparatus according to an embodiment of the present invention;

FIG. 3 is a simplified diagram of an optical switching device according to an embodiment of the present invention;

FIG. 4 is a detailed diagram of a mirror array coupled to drive circuitry according to an embodiment of the present invention;

FIG. 4A is a detailed diagram of a mirror array coupled to drive circuitry according to an embodiment of the present invention;

FIG. 5 is a more detailed diagram of a mirror coupled to a group of electrodes according to an embodiment of the present invention;

FIG. 6 is a more detailed diagram of a mirror coupled to a group of electrodes according to an embodiment of the present invention;

FIG. 7 is a detailed side view diagram of a mirror coupled to a substrate and electrodes according to an embodiment of the present invention;

FIG. 8 is a simplified block diagram of functional blocks in a mirror array device according to an embodiment of the present invention;

FIG. 9 is a simplified side view diagram of an illustration of a permittivity model according to an embodiment of the present invention;

FIGS. 10 and 11 are simplified plots of permittivity ploted against other parameters according to embodiments of the present invention;

FIG. 12 is a simplified side view diagram of an illustrations of a capacitance model according to an embodiment of the present invention; and

FIG. 13 is a simplified plot of pull-in as a function of permittivity according to an embodiment of the present invention

### DESCRIPTION OF THE SPECIFIC EMBODIMENTS

According to the present invention, a technique including a device for optical switching is provided. More particularly, the invention provides an integrated circuit and mirror device having a novel electrode configuration. Merely by way of example, the present invention is implemented using such a device in a wide area network for long haul telecommunications, but it would be recognized that the invention has a much broader range of applicability. The invention can be applied to other types of networks including local area networks, enterprise networks, and the like.

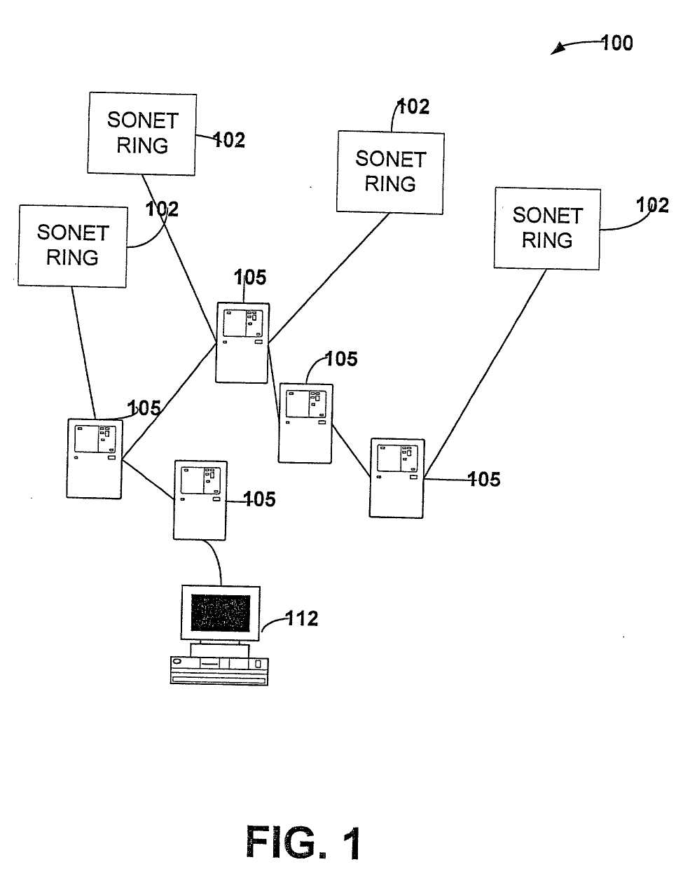

FIG. 1 is simplified diagram 100 of a optical switching network according to an embodiment of the present invention. This diagram is merely an example, which should not unduly limit the scope of the claims herein. One of ordinary skill in the art would recognize many other variations, modifications, and alternatives. As shown, the diagram illustrates an optical network system 100 including a plurality of SONET rings 102. Each of the SONET rings is coupled to one or more network switching systems 105, which are coupled to each other. The network switching systems can be coupled to long haul optical network system. In a specific embodiment, each of the switching systems switches an optical signal from one of the rings to another one of the rings, where the transmission path is substantially optical. That is, the signal is not converted into an electrical signal via an optoelectronic device, which is coupled to an electrical switch that switches the signal. In the present embodiment, the transmission path is substantially optical. Further details of the switching system are provided below.

Although the above has been described in terms of specific hardware features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

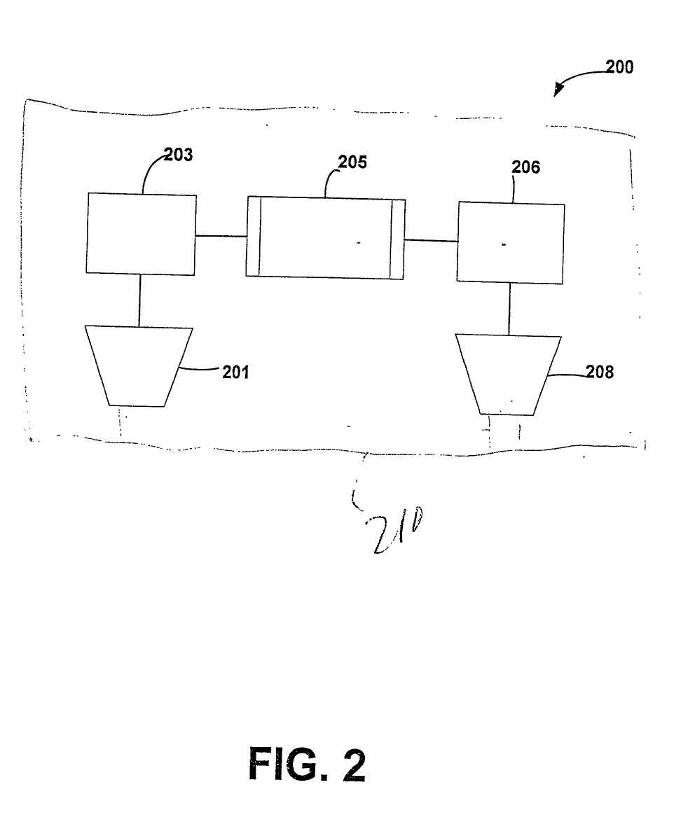

FIG. 2 is a simplified diagram of an optical switching apparatus 200 according to an embodiment of the present invention. This diagram is merely an example, which should not unduly limit the scope of the claims herein. One of ordinary skill in the art would recognize many other variations, modifications, and alternatives. As shown, the apparatus 200 includes a variety of features such as input source 201 (from fiber bundle) and output 208. The input source is coupled to housing including lens array 203. Lens array is coupled to mirror arrays 205. Further details of the mirror arrays are provided below. The mirror arrays are coupled to lens array 206, which couples to output fiber bundle 208.

As merely an example, the signal pathway traverses through the apparatus from input source 201 to output 208. Here, the signal pathway begins at the input source 201, which is from the fiber bundle. The signal traverses through a lens in the lens array 203, which focuses the signal. The signal traverses through the mirror arrays, which switch the signal between any one of a plurality of output fibers. The signal traverses from the mirror arrays to a lens, which is on lens array 206 to focus the signal. The signal is then output 208. Other steps can be performed depending upon the embodiment.

The present apparatus provides a pure optical pathway during switching in preferred embodiments. Preferably, the optical pathway is substantially free from any electrical switching of conventional devices. Other benefits would be recognized by one of ordinary skill in the art.

Additionally, the apparatus can become smaller in size using the novel configuration, and has a better form factor. In a specific embodiment, the apparatus has a small form factor. The form factor can be a few inches or less per side. In some embodiments, the apparatus is sealed using a non-reactive gas. The gas can be selected from any suitable compounds. For example, the gas can include nitrogen, argon, helium, and the like. The gas is preferably free from any oxygen bearing compounds, which can lead to oxidation. The sealed apparatus has a submicron (e.g., 0.5 or less) sized particle count of less than 10 ppm. The various features from input source 201 through output 208 are sealed from the environment.

The system also does not include electrical devices, which can be prone to error and the like. Since a lot of conventional electrical hardware has been eliminated, the present apparatus is reliable and is less prone to error. The apparatus also has a modular design, which can be easy to repair and/or replace. Here, a technician can easily remove the apparatus from the network and replace it with another apparatus. The overall system switching speed is 50 milliseconds or less in the apparatus for conventional networks, but can be much lower in other environments. In the present invention, the switching speed for the apparatus is 15 milliseconds or less or even 5 milliseconds or less. Preferably, the apparatus also conforms to Telecordia standards. There are many other benefits, which would be recognized by one of ordinary skill in the art.

Although the above has been described in terms of specific hardware features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

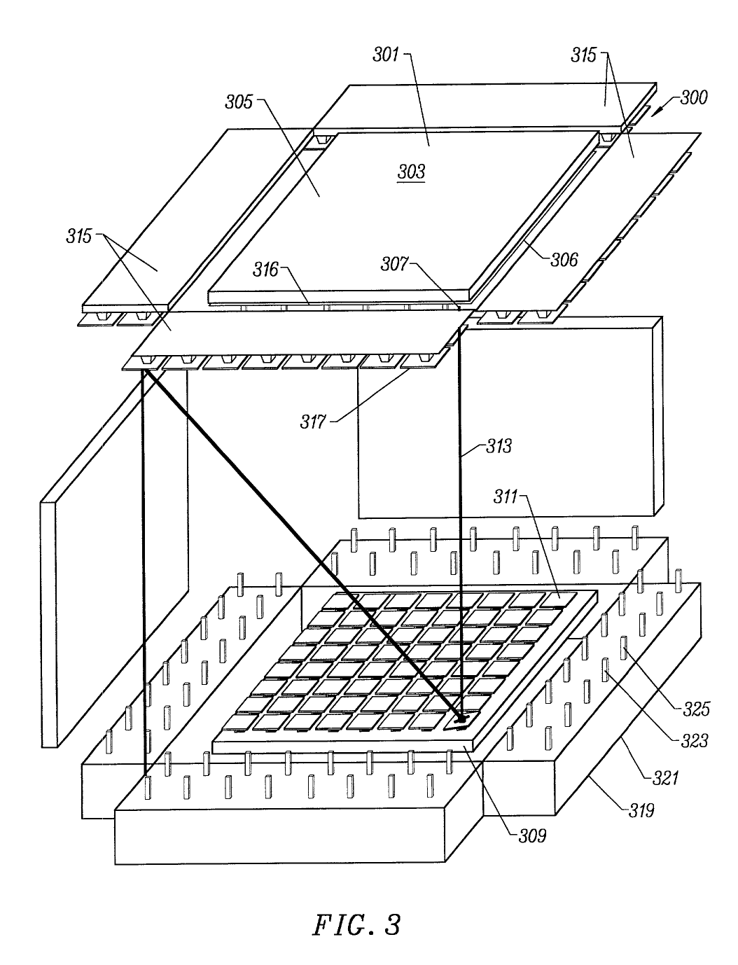

FIG. 3 is a simplified diagram of an optical switching device 300 according to an embodiment of the present invention. This diagram is merely an example, which should not unduly limit the scope of the claims herein. One of ordinary skill in the art would recognize many other variations, modifications, and alternatives. As shown, the device 300 for switching one of a plurality of optical signals from a plurality of optical fibers 301 is provided. The device has an input fiber bundle housing 303 comprising an outer side 305 and an inner side 306. The input fiber bundle housing has a plurality of sites 307 oriented in a spatial manner on the outer side for coupling to a plurality of input optical fibers. Each of the input optical fibers is capable of transmitting an optical signal. Preferably, the signal is transmitted through a lens, which is described in more detail below. The apparatus also has a first mirror array 309 disposed facing the inner side of the input fiber bundle housing. The first mirror array 309 includes a plurality of mirrors 311. Each of the mirrors 311 corresponds to one 313 of the sites on the outer side of the input fiber bundle housing. A second mirror array 315 is disposed facing the first mirror array. The second mirror array is also disposed around a periphery 316 of the input fiber bundle housing. The second mirror array also has a plurality of mirrors 317, where each of the mirrors is capable of directing at least one signal from one of the mirrors on the first mirror array. The device has an output fiber bundle housing 319 comprising an outer side 321 and an inner side 323. The output fiber bundle housing has a plurality of sites 325 oriented in a spatial manner on the outer side for coupling to a plurality of output optical fibers. Each of the sites is capable of receiving at least one signal from one of the second mirrors.

The housing is made of a suitable material that is sufficiently rigid to provide a structural support. Additionally, each housing also has sufficient characteristics to house a fiber optic member. Furthermore, the material also has the ability to provide an array of fiber optic sites, which house fiber optic members. The material can include a conductor, an insulator, or a semiconductor, or any combination of these, as well as multi-layered structures. The housing is preferably made of a similar material as the mirror array to cancel out any thermal expansion/contraction influences. Preferably, the material is silicon, but can also be other materials. Desirable, the material is also easy to machine and resists environmental influences. The housing also is capable of coupling to a lens and/or lens array, which will be described in more detail below.

The mirror can be any suitable mirror for adjusting a deflection of an optical signal(s). The mirror can be suspended on torsion bars, which adjust a spatial positioning of the mirrors. The torsion bars can be driven by electrostatic drive means, but can be others. As merely an example, U.S. Pat. No. 6,044,705 assigned to Xros, Inc., Sunnyvale, Calif. describes such a mirror in a specific manner. Alternatively, U.S. Pat. No. 4,317,611, assigned to International Business Machines Corporation, also describes such a mirror. It would be recognized by one of ordinary skill in the art that many other variations, alternatives, and modifications can exist.

Although the above has been described in terms of where the output arrays are split into a plurality of smaller arrays, the input arrays can also be split into a plurality of smaller arrays. Here, the output array would be a single piece larger array. Alternatively, each of the arrays can be split into a plurality of smaller sections or arrays. Each of these arrays can be of a similar size or a different size, depending upon the embodiment. The arrays can also be in a variety of shapes such as annular, trapezoidal, a combination of these, and others. These and other configurations would be recognized by one of ordinary skill in the art, where there can be many variations, modifications, and alternatives.

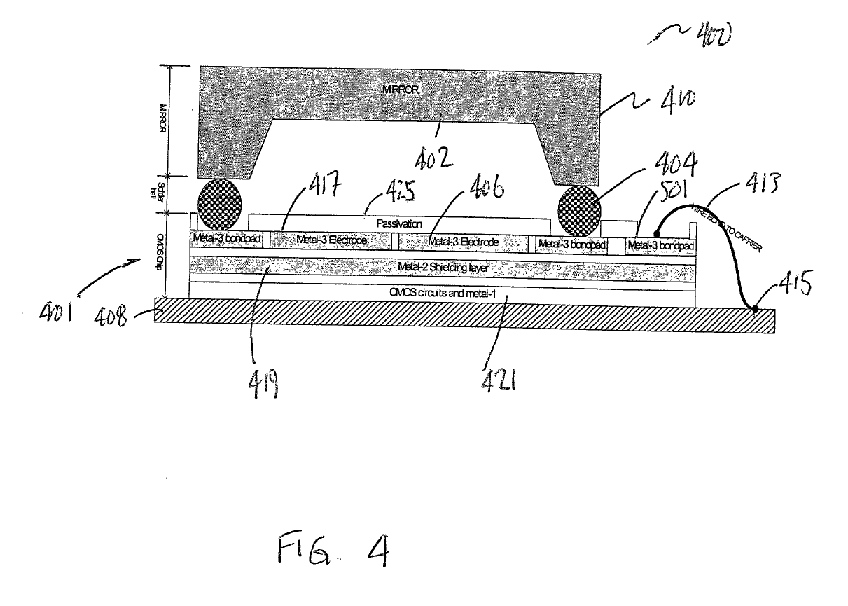

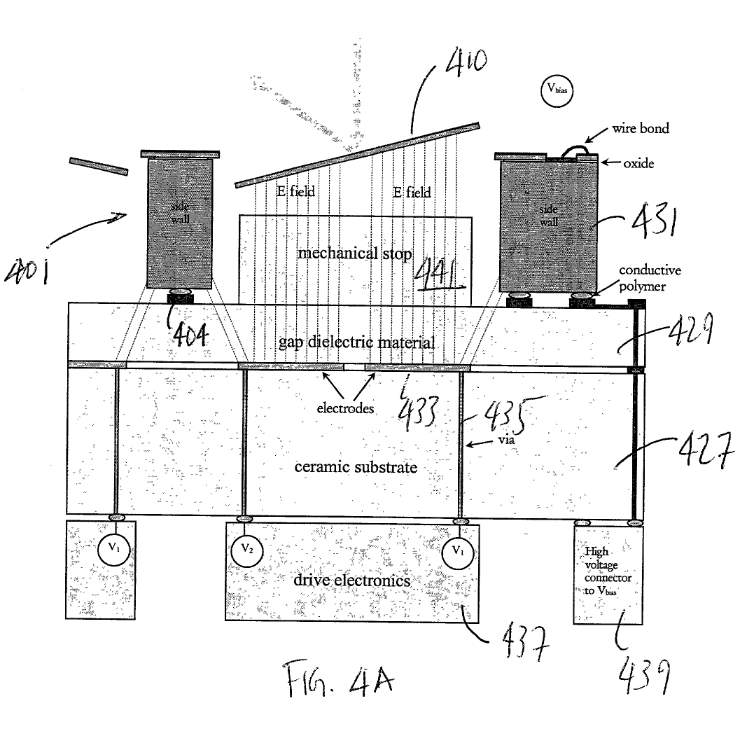

FIG. 4 is a detailed diagram of a mirror array coupled to drive circuitry 400 according to an embodiment of the present invention. This diagram is merely an example which should not unduly limit the scope of the claims herein. One of ordinary skill in the art would recognize many other variations, modifications, and alternatives. As shown, the mirror array 410 couples to substrate 401, which was previously detached from the mirror array. The mirror array can be one of the above, as well as others, which are driven by electrode devices. The mirror array and substrate couple to each other through bonding layer 404. The substrate is often a silicon substrate, which can be made using a semiconductor fabrication process or processes. The silicon substrate can include a variety of electrical circuits for driving electrodes 406, which move each one of the mirrors 402 on the mirror array.

As shown, the silicon substrate has a plurality of electrode groups 406 on an upper surface portion of the substrate. A dielectric layer underlies the electrode groups. Each of the electrodes couples to lines, which couple to drive circuitry. The dielectric layer can be any suitable material such as silicon dioxide, silicon nitride, doped silicon glass, spin-on-glass, and the like. The dielectric layer can be a single layer or multiple layers. The electrodes groups are made of a suitable conductive material, such as aluminum, copper, gold, aluminum alloys, and the like. The material can also be titanium, tungsten, or other barrier type material. The electrodes can also be any combination of these, as well as others. In some embodiments, a dielectric layer or insulating layer can be formed overlying the electrodes. The dielectric layer can be used to protect the electrodes. The dielectric layer can be can be any suitable material such as silicon dioxide, silicon nitride, aluminum dioxide, doped silicon glass, spin-on-glass, and the like. The dielectric layer can be a single layer or multiple layers. The dielectric layer, however, is thin enough to allow the electrodes to influence movement of the mirrors on the array.

The substrate includes at least first 421, second 419, and third 421 metal layers, but can also be fewer metal layers. The second metal layer can be used as a shielding layer, which electrically isolates the integrated circuit device layer from the electrodes. The third metal layer can be used for the electrodes, as noted above. The first metal layer can be used for integrated circuit elements including drive circuitry, sense electrodes for the mirror, which are able to pick up the very low capacitance values without suffering the noise from the interconnects. The substrate can be made using technology of NMOS, CMOS, bipolar, or any combination of these. In an embodiment using CMOS circuitry, the substrates includes sense and drive electrodes, multiplexing circuitry (MUX) to multiplex the interconnects from the mirror electrodes to reduce the number of connections to the outside world, e.g., wire bonds. The substrate also has drive hold circuitry (and associated control circuitry) to reduce the overhead necessary to maintain mirror position. Further details of such circuitry are provided below.

In a specific embodiment, the bonding layer can be any suitable material or materials to connect the mirror array to the substrate. The bonding layer can be a plurality of bumps 404. In one embodiment, the plurality of bumps can be made using an IBM C4 process from flip chip technology, i.e., IBM C4 process—Controlled Collapse Chip Connection—aka Flip-Chip Attach (FCA), whereby the chip to be bonded is pre-treated with a solder “bump” on each of the bond pads and flipped over and aligned with the underlying substrate for reflow. This allows for high-density (100s to 1000s of interconnects) in a relatively small area. Alternatively, the bonding layer can be made using a deposition process, a screen printing process, an ink jet printing process, a photolithography process, a eutectic bonding layer, a plated bonding layer, any combination of these and the like. The integrated array and substrate are packaged in a carrier 408. In a specific embodiment, the carrier can be made of a ceramic material. Alternatively, it could be a plastic material. Bonding wires 413 connect each bonding pad 501 to an interconnect 415. Of course, the specific configuration can depend highly upon the embodiment.

In a specific embodiment, the device includes a capacitance spacer layer 425 disposed between each of the electrode groups and its respective mirror. The mirror is one from the mirror array. The capacitance spacer layer is made of a suitable dielectric material or materials. The dielectric material has a suitable dielectric constant. The capacitance spacer layer is made of a selected thickness that sets a predetermined capacitance level between the electrodes and mirrors. The capacitance layer is patterned using a photolitographic process. The capacitance spacer layer is formed to provide openings overlying the bonding layer. In a specific embodiment, the capacitance layer is made in order to make the capacitance sensing feasible. Here, a delta capacitance often needs to be sufficient large. In a specific embodiment, the delta capacitance is often a few fF or may be more. Various parameters can be modified to increase the capacitance. The parameters include the permittivity of the media, and the gap between the mirror and sensing electrodes, among other factors. In a specific embodiment, the permittivity of the media is provided change the permittivity between the mirror surface and electrodes. In addition to the permittivity of the media, there is a permittivity of the gap between the backside surface of the mirror and the upper surface of the capacitance spacer layer. The exact thickness of the media and the gap can be adjusted to achieve a suitable result. Of course, one of ordinary skill in the art would recognize many other variations, modifications, and alternatives.

In a specific embodiment, the capacitance spacer layer is a dielectric material that is inserted between the electrodes layer and the mirror to obtain a desired gap. A high permittivity of the dielectric material is preferred as it reduces the drive voltage. The same dielectric material is used in the mechanical stop in some embodiments. The thickness of this stop is chosen such that the mirror has sufficient tilt range and contacts the stop prior to pull-in. The spacer layer is often made of a suitable material that will prevent mechanical damage to it and the edge of the mirror. The spacer layer can also serve as insulation for preventing one (or more) of the electrodes from shorting to its respective mirror. The capacitance spacer layer can be coated with a variety of materials for mechanical protection to scratches, dents, etc. The coating can be a suitable material such as a hard material and/or a barrier material such as a nitrogen bearing species, a carbon bearing species, and others which make the dielectric material suitable to prevent mechanical damage to the mirror.

FIG. 4A is a detailed diagram of a mirror array coupled to drive circuitry according to an embodiment of the present invention. This diagram is merely an example which should not unduly limit the scope of the claims herein. One of ordinary skill in the art would recognize many other variations, modifications, and alternatives. In the present embodiment, the mirror array is coupled to substrate 427. As shown, the mirror array 410 couples to substrate 401, which was previously detached from the mirror array. The substrate 401 includes side wall 431, for example, which houses the mirror. The mirror array can be one of the above, as well as others, which are driven by electrode devices. The mirror array and substrate couple to each other through bonding layer 404. In a specific embodiment, the bonding layer can be any suitable material or materials to connect the mirror array to the substrate. The bonding layer can be a plurality of bumps 404. In one embodiment, the plurality of bumps can be made using an IBM C4 process from flip chip technology, i.e., IBM C4 process—Controlled Collapse Chip Connection—aka Flip-Chip Attach (FCA), whereby the chip to be bonded is pre-treated with a solder “bump” on each of the bond pads and flipped over and aligned with the underlying substrate for reflow. This allows for high-density (100s to 1000s of interconnects) in a relatively small area. Alternatively, the bonding layer can be made using a deposition process, a screen printing process, an ink jet printing process, a photolithography process, a eutectic bonding layer, a plated bonding layer, any combination of these and the like. The substrate is often a silicon substrate, which can be made using a semiconductor fabrication process or processes.

The substrate including the mirror array is coupled to substrate 427. The substrate 427 has a dielectric gap material 429. The dielectric material underlies the electrode groups 433. Each of the electrodes couples to lines 435, which couple to drive circuitry 437 through vias. The dielectric layer can be any suitable material such as silicon dioxide, silicon nitride, doped silicon glass, spin-on-glass, and the like. The dielectric layer can be a single layer or multiple layers. The electrodes groups are made of a suitable conductive material, such as aluminum, copper, gold, aluminum alloys, and the like. The material can also be titanium, tungsten, or other barrier type material. The electrodes can also be any combination of these, as well as others. In some embodiments, a dielectric layer or insulating layer can be formed overlying the electrodes. The dielectric layer can be used to protect the electrodes. The dielectric layer can be can be any suitable material such as silicon dioxide, silicon nitride, aluminum dioxide, doped silicon glass, spin-on-glass, and the like. The dielectric layer can be a single layer or multiple layers. The dielectric layer, however, is thin enough to allow the electrodes to influence movement of the mirrors on the array.

Overlying the dielectric layer is mechanical stop layer 441. The mechanical stop layer is patterned and made of a selected height and width to act as a stop for the mirror 410. The stop layer is made of a suitable dielectric material or materials. The dielectric material has a suitable dielectric constant. The stop layer is made of a selected thickness that sets a predetermined capacitance level between the electrodes and mirrors. The layer is patterned using a photolitographic process. In a specific embodiment, the stop layer is made in order to make the capacitance sensing feasible. Here, a delta capacitance needs to be sufficient large. In a specific embodiment, the delta capacitance is often a few fF. Various parameters can be modified to increase the capacitance. The parameters include the permittivity of the media, and the gap between the mirror and sensing electrodes, among other factors. In a specific embodiment, the permittivity of the media is provided change the permittivity between the mirror surface and electrodes. In addition to the permittivity of the media, there is a permittivity of the gap between the backside surface of the mirror and the upper surface of the capacitance spacer layer. The exact thickness of the media and the gap can be adjusted to achieve a suitable result. Of course, one of ordinary skill in the art would recognize many other variations, modifications, and alternatives.

In a specific embodiment, the capacitance spacer layer is a dielectric material that is inserted between the electrodes layer and the mirror to obtain a desired gap. A high permittivity of the dielectric material is preferred as it reduces the drive voltage. The same dielectric material is used in the mechanical stop in some embodiments. The thickness of this stop is chosen such that the mirror has sufficient tilt range and contacts the stop prior to pull-in. The spacer layer is often made of a suitable material that will prevent mechanical damage to it and the edge of the mirror. The spacer layer can also serve as insulation for preventing one (or more) of the electrodes from shorting to its respective mirror. The capacitance spacer layer can be coated with a variety of materials for mechanical protection to scratches, dents, etc. The coating can be a suitable material such as a hard material and/or a barrier material such as a nitrogen bearing species, a carbon bearing species, and others which make the dielectric material suitable to prevent mechanical damage to the mirror.

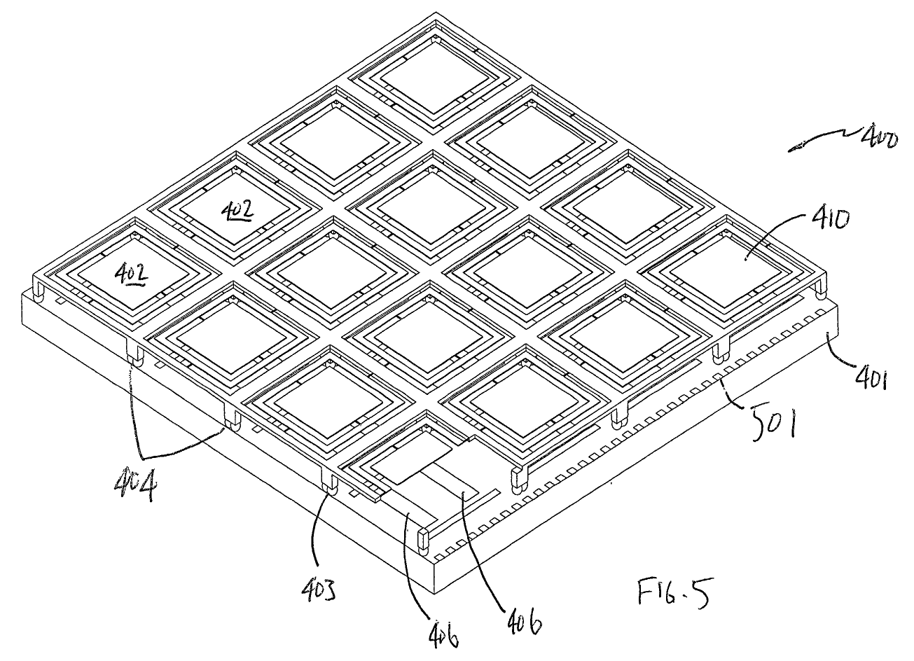

FIG. 5 is a more detailed diagram of a mirror array coupled to a group of electrodes shown in three dimensions 400 according to an embodiment of the present invention. This diagram is merely an example which should not unduly limit the scope of the claims herein. One of ordinary skill in the art would recognize many other variations, modifications, and alternatives. Like reference numerals are used in this Fig. as some of the others, but are not intended to be limiting. As shown, the mirror array 410 couples to substrate 401, which was previously detached from the mirror array. The mirror array can be one of the above, as well as others, which are driven by electrode devices. The mirror array and substrate couple to each other through bonding layer 403. The substrate is often a silicon substrate, which can be made using a semiconductor fabrication process or processes. The silicon substrate can include a variety of electrical circuits for driving electrodes 406, which move each one of the mirrors 402 on the mirror array.

As shown, the silicon substrate has a plurality of electrode groups 406 an upper surface portion of the substrate. A dielectric layer underlies the electrode groups. Each of the electrodes couples to lines, which couple to drive circuitry. The dielectric layer can be any suitable material such as silicon dioxide, aluminun dioxide, silicon nitride, doped silicon glass, spin-on-glass, and the like. The dielectric layer can be a single layer or multiple layers. The electrodes groups are made of a suitable conductive material, such as aluminum, copper, aluminum alloys, and the like. The material can also be titanium, tungsten, or other barrier type material. The electrodes can also be any combination of these, as well as others. In some embodiments, a dielectric layer or insulating layer can be formed overlying the electrodes. The dielectric layer can be used to protect the electrodes. The dielectric layer can be can be any suitable material such as silicon dioxide, silicon nitride, doped silicon glass, spin-on-glass, and the like. The dielectric layer can be a single layer or multiple layers. The dielectric layer, however, is thin enough to allow the electrodes to influence movement of the mirrors on the array.

The substrate includes at least first and second metal layers. A third metal layer can also be included. The second metal layer can be used for the electrodes 406, as noted above. The first metal layer can be used for integrated circuit elements including drive circuitry, sense electrodes for the mirror, which are able to pick up the very low capacitance values without suffering the noise from the interconnects. The substrate can be made using technology of NMOS, CMOS, bipolar, or any combination of these. In an embodiment using CMOS circuitry, the substrates includes sense and drive electrodes, multiplexing circuitry (MUX) to multiplex the interconnects from the mirror electrodes to reduce the number of connections to the outside world, e.g., wire bonds. The substrate also has drive hold circuitry (and associated control circuitry) to reduce the overhead necessary to maintain mirror position. Further details of such circuitry are provided below.

In a specific embodiment, the bonding layer can be any suitable material or materials to connect the mirror array to the substrate. The bonding layer can be a plurality of bumps 404. In one embodiment, the plurality of bumps can be made using an IBM C4 process from flip chip technology, i.e., IBM C4 process—Controlled Collapse Chip Connection—aka Flip-Chip Attach (FCA), whereby the chip to be bonded is pre-treated with a solder “bump” on each of the bond pads and flipped over and aligned with the underlying substrate for reflow. This allows for high-density (100s to 1000s of interconnects) in a relatively small area. The integrated array and substrate are packaged in a carrier. Alternatively, the bonding layer can be made using a deposition process, a screen printing process, an ink jet printing process, a photolithography process, a eutectic bonding layer, a plated bonding layer, any combination of these and the like. In a specific embodiment, the carrier can be made of a ceramic material. Alternatively, it could be a plastic material. Bonding wires connect each bonding pad 501 to an interconnect. As shown, the bonding pads are formed on the substrate along a periphery of the mirror array. In a specific embodiment, the bonding pads are provided on the same metal layer as the electrodes. Alternatively, the bonding pads can also be provided on a different metal layer. Of course, the specific configuration can depend highly upon the embodiment.

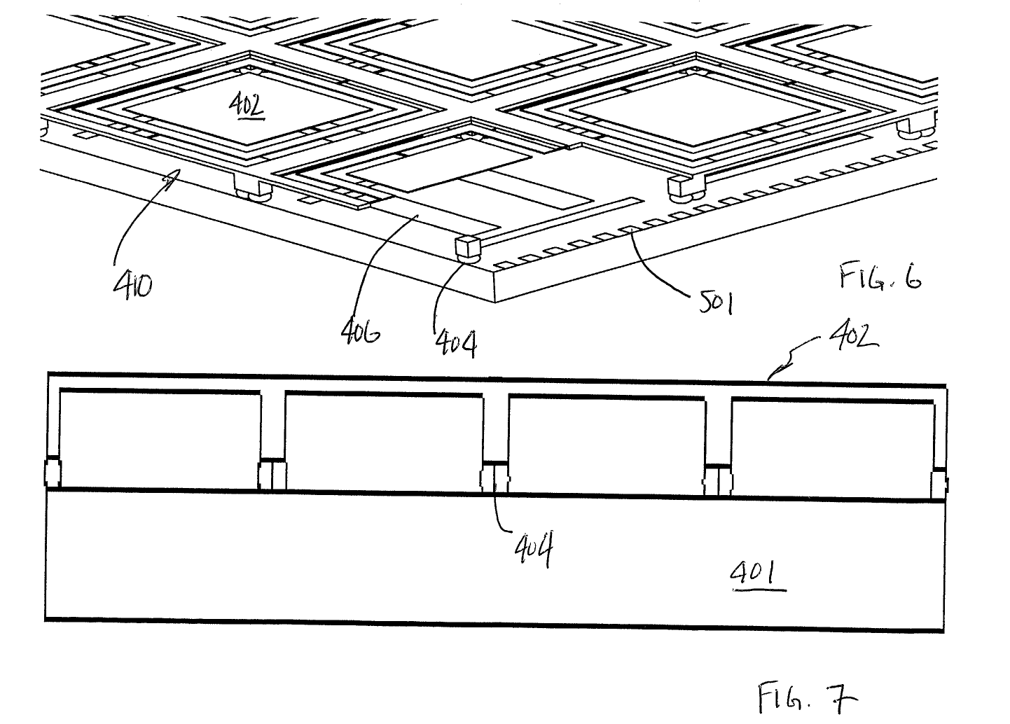

FIG. 6 is a more detailed diagram of a mirror array coupled to a substrate and electrodes according to an embodiment of the present invention. This diagram is merely an example which should not unduly limit the scope of the claims herein. One of ordinary skill in the art would recognize many other variations, modifications, and alternatives. Like reference numerals are used in this Fig. and some of the others, but are not intended to be limiting. As shown, the mirror array 410 couples to substrate 401, which was previously detached from the mirror array. The mirror array can be one of the above, as well as others, which are driven by electrode devices. The mirror array and substrate couple to each other through bonding layer 404, which includes each 404 of the bonding bumps. The substrate is often a silicon substrate, which can be made using a semiconductor fabrication process or processes. The silicon substrate can include a variety of electrical circuits for driving electrodes 406, which move each one of the mirrors 402 on the mirror array.

As shown, the silicon substrate has a plurality of electrode groups 406 on an upper surface portion of the substrate. A dielectric layer underlies the electrode groups. Each of the electrodes couples to lines, which couple to drive circuitry. The dielectric layer can be any suitable material such as silicon dioxide, silicon nitride, doped silicon glass, spin-on-glass, and the like. The dielectric layer can be a single layer or multiple layers. The electrodes groups are made of a suitable conductive material, such as aluminum, copper, gold, aluminum alloys, and the like. The material can also be titanium, tungsten, or other barrier type material. The electrodes can also be any combination of these, as well as others. In some embodiments, a dielectric layer or insulating layer can be formed overlying the electrodes. The dielectric layer can be used to protect the electrodes. The dielectric layer can be can be any suitable material such as silicon dioxide, silicon nitride, doped silicon glass, spin-on-glass, and the like. The dielectric layer can be a single layer or multiple layers. The dielectric layer, however, is thin enough to allow the electrodes to influence movement of the mirrors on the array.

The substrate includes at least first and second metal layers. The second metal layer can be used for the electrodes, as noted above. The first metal layer can be used for integrated circuit elements including drive circuitry, sense electrodes for the mirror, which are able to pick up the very low capacitance values without suffering the noise from the interconnects. The substrate can be made using technology of NMOS, CMOS, bipolar, or any combination of these. In an embodiment using CMOS circuitry, the substrates includes sense and drive electrodes, multiplexing circuitry (MUX) to multiplex the interconnects from the mirror electrodes to reduce the number of connections to the outside world, e.g., wire bonds. The substrate also has drive hold circuitry (and associated control circuitry) to reduce the overhead necessary to maintain mirror position. Further details of such circuitry are provided below.

In a specific embodiment, the bonding layer can be any suitable material or materials to connect the mirror array to the substrate. The bonding layer can be a plurality of bumps 404. In one embodiment, the plurality of bumps can be made using an IBM C4 process from flip chip technology, i.e., IBM C4 process—Controlled Collapse Chip Connection—aka Flip-Chip Attach (FCA), whereby the chip to be bonded is pre-treated with a solder “bump” on each of the bond pads and flipped over and aligned with the underlying substrate for reflow. This allows for high-density (100s to 1000s of interconnects) in a relatively small area. Alternatively, the bonding layer can be made using a deposition process, a screen printing process, an ink jet printing process, a photolithography process, a eutectic bonding layer, a plated bonding layer, any combination of these and the like. The integrated array and substrate are packaged in a carrier 408. In a specific embodiment, the carrier can be made of a ceramic material. Alternatively, it could be a plastic material. Bonding wires connect each bonding pad 501 to an interconnect. As shown, the bonding pads are formed on the substrate along a periphery of the mirror array. Of course, the specific configuration can depend highly upon the embodiment.

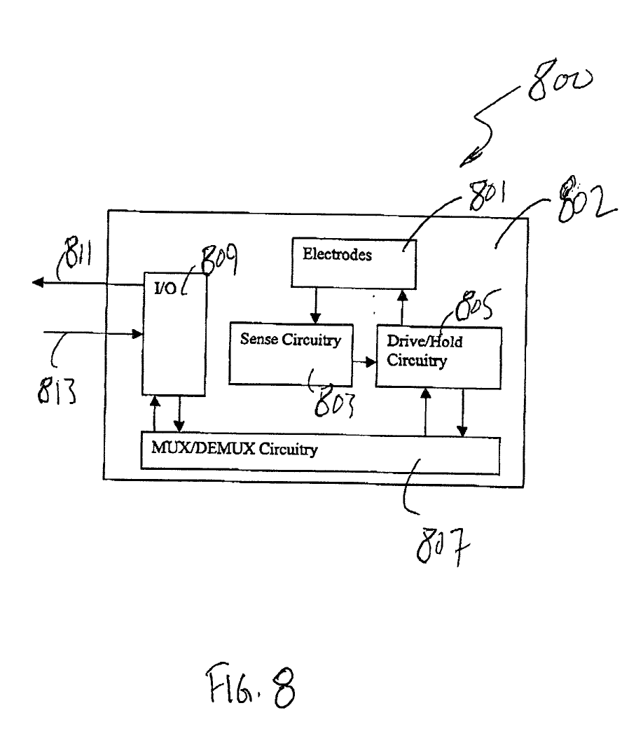

FIG. 7 is a detailed side view diagram of a mirror array coupled to a substrate and electrodes according to an embodiment of the present invention. This diagram is merely an example which should not unduly limit the scope of the claims herein. One of ordinary skill in the art would recognize many other variations, modifications, and alternatives. Like reference numerals are used in this Fig. as some of the others, but are not intended to be limiting. The side view diagram includes substrate 401, bonding layer bumps 404, mirror 402, and other elements. The silicon substrate has a plurality of electrode groups on an upper surface portion of the substrate. A dielectric layer underlies the electrode groups. Each of the electrodes couples to lines, which couple to drive circuitry. The dielectric layer can be any suitable material such as silicon dioxide, aluminum dioxide, silicon nitride, doped silicon glass, spin-on-glass, and the like. The dielectric layer can be a single layer or multiple layers. The electrodes groups are made of a suitable conductive material, such as aluminum, copper, aluminum alloys, gold, and the like. The material can also be titanium, tungsten, or other barrier type material. The electrodes can also be any combination of these, as well as others. In some embodiments, a dielectric layer or insulating layer can be formed overlying the electrodes. The dielectric layer can be used to protect the electrodes. The dielectric layer can be can be any suitable material such as silicon dioxide, silicon nitride, doped silicon glass, spin-on-glass, and the like. The dielectric layer can be a single layer or multiple layers. The dielectric layer, however, is thin enough to allow the electrodes to influence movement of the mirrors on the array. An example of functionality that can be performed using any one of these integrated devices is provided below.

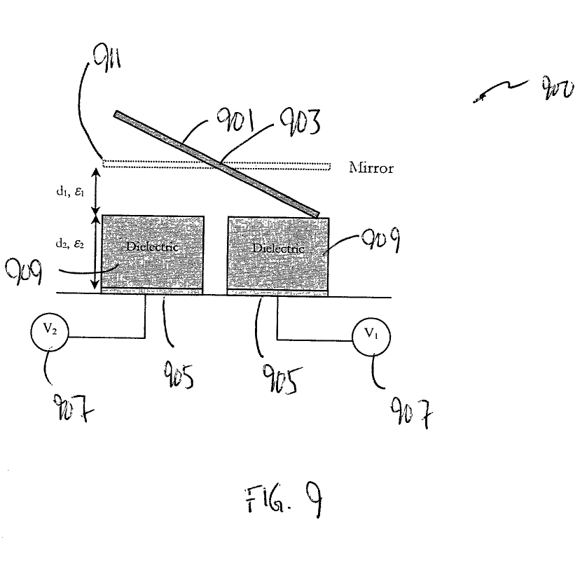

FIG. 8 is a simplified block diagram 800 of functional blocks in a mirror array device according to an embodiment of the present invention. This diagram is merely an example which should not unduly limit the scope of the claims herein. One of ordinary skill in the art would recognize many other variations, modifications, and alternatives. The block diagram 800 includes substrate 802. The substrate has a variety of functional blocks such as electrodes 801, drive/hold circuitry 805, multiplexing/demultiplexing circuitry 807, sense circuitry 803, an I/O circuit 809, and others. The above blocks are used to perform operations of the mirror array. Here, the operations include switching the position of any one of the mirrors in the array from a first position to a second position. The operations also include maintaining a present position of any one of the mirrors. These and other examples are provided below in more detail. One of ordinary skill in the art would recognize, however, many other alternatives, modifications, and variations.

A method according to the present invention may be briefly provided as follows:

(1) Select a position for switching one of the input beam signals from a mirror on an input fiber bundle to an output fiber in an output array using a controller;

(2) Derive position signals from the controller, which has a lookup table including voltages in reference to angular positions for each of the mirrors;

(3) Address selected mirror using multiplexing/demultiplexing circuitry;

(4) Transfer x-data and y-data from lookup table from controller through digital signal lines to integrated circuit elements;

(5) Store x-data and y-data into respective registers;

(6) Convert x-data and y-data into analog signals through digital analog converters;

(7) Compare present position with new selected position through sense circuitry, while maintaining present position, e.g., error correction;

(8) If present position is different from new position, switch the mirror position by transmitting voltage signals to drive circuitry;

(9) Drive electrode or electrode pair to move mirror from present position to new position;

(10) Maintain mirror position by supplying selected signals from the controller to the drive circuitry; and

(11) Perform other steps, as desired.

The above sequence of steps is merely an example, which should not unduly limit the scope of the claims herein. As shown, the present steps provide a way to actuate or switch one of the mirrors in the array from a first position to a second position to direct a beam from an input fiber to any one of a plurality of output fibers. Alternatively, the steps can be used to maintain a present position of any one of the mirrors, where the mirror may move in one direction or another direction due to noise or the like. Further details of these steps are provided in reference to the Fig. below.

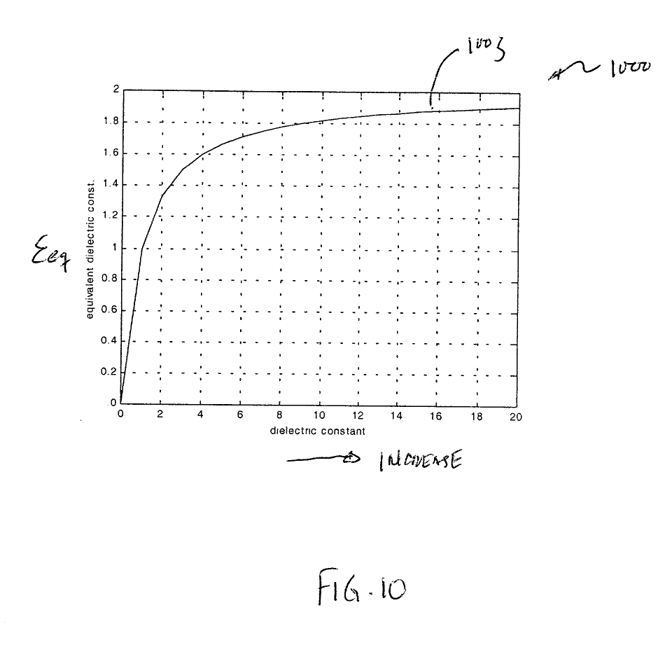

FIG. 9 is a simplified diagram 1000 illustrating a method and device according to an embodiment of the present invention. This diagram is merely an example which should not unduly limit the scope of the claims herein. One of ordinary skill in the art would recognize many other variations, modifications, and alternatives. Here, a user selects a position for switching one of the input beam signals 1003 from one of the output fibers in the array of a switching device using a controller via a high level network management interface device. The switching device can be similar to the one noted above but can also be others. For example, the switching device can also be similar to the one described in U.S. Pat. No. 6,044,705 assigned to Xros, Inc., Sunnyvale, Calif. describes such a mirror in a specific manner. It would be recognized by one of ordinary skill in the art that many other variations, alternatives, and modifications can exist. The switching device includes substrate 1005, which includes a variety of integrated circuit elements for sensing and controlling any one of the mirrors in the mirror array. The substrate also includes electrodes 1007, which are coupled to the substrate. The substrate also includes a housing 1009, which holds a mirror 1001 from a mirror array. Signals of the selected position are derived from the controller, which has a lookup table including voltages in reference to angular positions for each of the mirrors. The lookup table has been provided from a calibration technique, which references voltage information with mirror positions for each mirror on the array. The signals include address information to selected a particular mirror from the array. Additionally, the signals include position information to selectively position the mirror to redirect a beam from an input fiber to an output fiber. Here, the controller sends signals to address the selected mirror using multiplexing/demultiplexing circuitry, for example. Next, the controller transfers position information including x-data and y-data from the lookup table through digital signal lines to integrated circuit elements. As shown, the x-data are provided on line 1010 and the y-data are provided on line 1011. The x-data are stored in register 1013, which maintains the data for use in the other circuit elements. Next, the x-data are converted from digital format into analog using the digital to analog converter (DAC) 1015 for use in the circuit elements.

The analog data representing the x-data are provided to controller 1017. The controller oversees the operation of the spatial positioning of the mirror 1001. As shown, the mirror includes a mirror surface 1002, which is disposed on a substrate 1004. In a specific embodiment, the controller monitors the present position of the mirror. Here, the mirror has certain positions relative to at least two axis, including an x-position and a y-position. The mirror pivots along the x-direction and also pivots along the y-direction to direct the beam from a selected input fiber to any one of a plurality of output fibers. The mirror has a variety of spatial positions. The controller receives signals from selected regions 1022 of the substrate to sensor 1021. As shown, the substrate includes a separate sense and drive electrode, which may be combined in other embodiments. The controller often compares the present position of the mirror with a new predetermined position of the mirror through sense circuitry, while maintaining the present position. Alternatively, the controller merely provides control feedback to the drive circuitry 1019 to maintain the position of the mirror. If the new predetermined position is different from the present position, the controller switches the mirror position by transmitting voltage signals to drive circuitry. The drive circuitry drives an electrode or electrode pair to move the mirror from the present position to the new predetermined position, which redirects a beam from an input fiber to one of the output fibers. Once the mirror is in the new predetermined position, the controller maintains the position by monitoring the position feedback from a sensing device and selectively applying voltage to one or more of the electrodes 1007, as needed.

The signals for the movement of the y-direction are similar in concept to the description above. The analog data representing the y-data are provided to controller 1017. The controller oversees the operation of the spatial positioning of the mirror 1001. As shown, the mirror includes a mirror surface 1002, which is disposed on a substrate 1004. In a specific embodiment, the controller monitors the present position of the mirror. Here, the mirror has certain positions relative to at least two axis, including an x-position and a y-position. The mirror pivots along the y-direction and also pivots along the x-direction, which has been explained, to direct the beam from a selected input fiber to any one of a plurality of output fibers. The mirror has a variety of spatial positions. The controller receives signals from selected regions of the substrate to a sensor. The controller often compares the present position of the mirror with a new predetermined position of the mirror through sense circuitry, while maintaining the present position. Alternatively, the controller merely provides control feedback to the drive circuitry to maintain the position of the mirror. If the new predetermined position is different from the present position, the controller switches the mirror position by transmitting voltage signals to drive circuitry. The drive circuitry drives an electrode or electrode pair to move the mirror from the present position to the new predetermined position, which redirects a beam from an input fiber to one of the output fibers. Once the mirror is in the new predetermined position, the controller maintains the position by selectively applying voltage to the electrodes. Further details of ways of modeling the present invention are provided by way of the Figs. below.

FIG. 9 is a simplified side view diagram of an illustration of a permittivity model according to an embodiment of the present invention. This diagram is merely an example which should not unduly limit the scope of the claims herein. One of ordinary skill in the art would recognize many other variations, modifications, and alternatives. As depicted in the Fig., the diagram 900 includes a mirror 901, which rotates about an axis 903. The mirror is driven by electrodes 905, which are coupled to voltage sources 907, including V1 and V2. Underlying the mirror is a dielectric layer 909, which includes two dielectric portions. Each of the portions defines a spacer layer including a dielectric material that changes the permittivity between the mirror and electrodes. Here, we define an equivalent permittivity ε_{eq} at a nominal position 911 expressed as follows:

$${ϵ}_{eq} = \frac{{ϵ}_{1} {ϵ}_{2} ( {d}_{1} + {d}_{2} )}{{ϵ}_{1} {d}_{1} + {ϵ}_{2} {d}_{2}}$$

where ε₁ defines a permittivity of a gap (e.g., air, nitrogen, other inert gas);

ε₂ defines a permittivity of a dielectric material (e.g., silicon dioxide);

d₁ defines a distance in the gap;

d₂ defines a thickness of the dielectric material; and

ε_{eq} defines an equivalent permittivity of the gap and dielectric material.

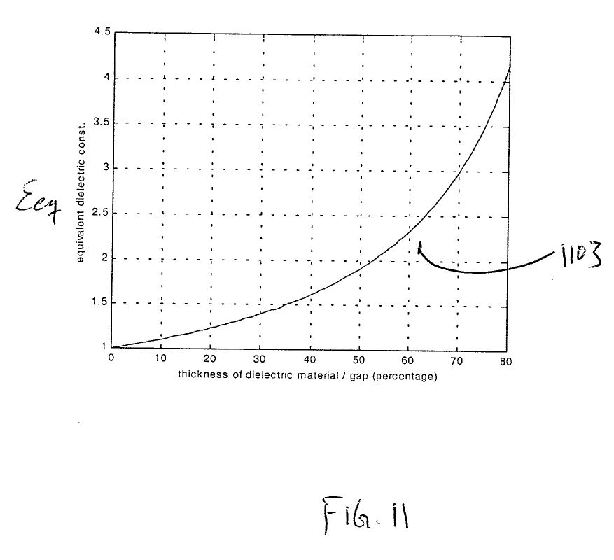

To show a relationship in the expression above, we have provided FIG. 10, which shows a simplified plot 1000 of the equivalent permittivity ε_{eq} vs. ε₂, the permittivity of the dielectric material on top of the electrodes. As shown, the horizontal axis represents a dielectric material constant and the vertical axis represents the equivalent permittivity. The equivalent permittivity approaches an asymptotic value 1003 as the permittivity of the dielectric material increases. This can be derived mathematically by taking a limit of the equivalent permittivity as follows:

$${lim }_{{ϵ}_{2} -> ∞} {ϵ}_{eq} = {lim}_{{ϵ}_{2} -> ∞} \frac{{ϵ}_{1} {ϵ}_{2} ( {d}_{1} + {d}_{2} )}{{ϵ}_{1} {d}_{1} + {ϵ}_{2} {d}_{2}} = \frac{{ϵ}_{1} ( {d}_{1} + {d}_{2} )}{{d}_{2}}$$

As ε₂ approaches infinity, the equivalent permittivity approaches a constant value determined by the permittivity of default media ε₁, its distance d₁ and the distance of the dielectric material d₂. According to the expression above, the equivalent permittivity is also a function of the thickness of the dielectric material.

As depicted in FIG. 11, the horizontal axis represents thickness of dielectric material/gap in percentage and the vertical axis represents the equivalent permittivity. As shown, the equivalent permittivity increases almost exponentially 1103 as the thickness of the dielectric material in relation to the gap increases. A model for capacitance is provided in reference to the Fig. below.

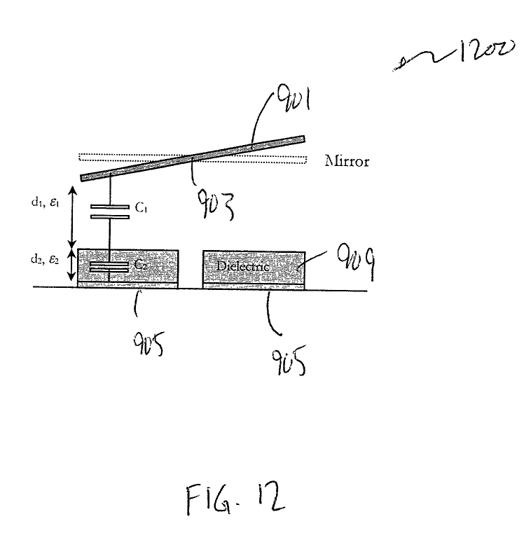

FIG. 12 is a simplified side view diagram 1200 of an illustration of a capacitance model according to an embodiment of the present invention. This diagram is merely an example which should not unduly limit the scope of the claims herein. One of ordinary skill in the art would recognize many other variations, modifications, and alternatives. Like reference numerals are used in the present Fig. as others for referencing purposes only without limiting the scope of the claims herein. As shown, the diagram 1200 includes a mirror 901, which rotates about an axis 903. The mirror is driven by electrodes 905, which are coupled to voltage sources. Underlying the mirror is a dielectric layer 909, which includes two dielectric portions. Each of the portions defines a spacer layer including a dielectric material that changes the permittivity between the mirror and electrodes. Here, we define an equivalent permittivity ε_{eq} at a nominal position expressed by the relationship above, where ε₁ defines a permittivity of a gap; ε₂ defines a perdmittivity of a dielectric material; d₁ defines a distance in the gap; d₂ defines a thickness of the dielectric material; and ε_{eq} defines an equivalent permittivity.

Additionally, capacitances are defined by C₁ and C₂, where C₁ defines the capacitance between (i.e., gap) the mirror and the dielectric material and C₂ defines the capacitance in the dielectric material. A total capacitance (C) can be written as follows:

$$\frac{1}{C} = \frac{1}{{C}_{1}} + \frac{1}{{C}_{2}}$$

$$or$$

$$C = \frac{{C}_{1} {C}_{2}}{{C}_{1} + {C}_{2}}$$

Based upon our studies, we now illustrate the influence of the dielectric material on the pull-in condition. Here, we have uncovered that the actuating voltage is a convex function of tilt angle, as expressed in more detail below.

To illustrate the operation of an embodiment of the present invention, we can form a simulation for a specific mirror configuration to show a pull-in condition of operation. The mirror sample can be designated with the dimensions listed in Table 1, for example.

TABLE 1
Torsion Mirror Dimension (sample)

| Parameter | Value | |
|---|---|---|
| mirror length | 1 | mm |
| mirror width | 1 | mm |
| mirror thickness | 4 | um |
| torsional bar length | 400 | um |
| torsional bar width | 2 | um |
| torsional bar thickness | 4 | um |
| electrode length | 1 | mm |
| electrode width | 0.5 | mm |
| max tilt angle | 8 | degrees |
| gap between mirror and | 200 | um |
| electrodes including | | |
| dielectric material | | |

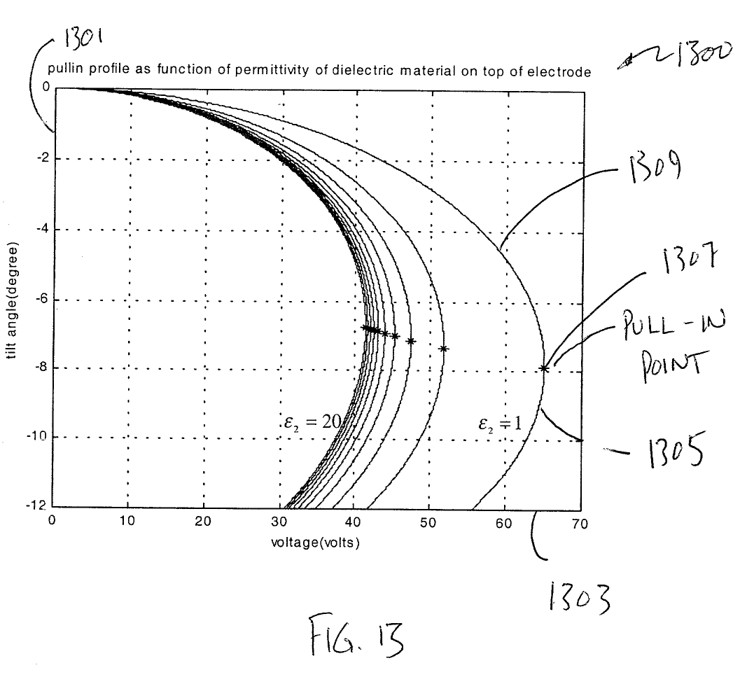

Using the values in Table 1, a relationship between tilt angle and actuation voltage is plotted 1300 in FIG. 13. This diagram is merely an example which should not unduly limit the scope of the claims herein. One of ordinary skill in the art would recognize many other variations, modifications, and alternatives. As shown, the relationship shows tilt angle plotted against applied voltage for different permittivity values of the dielectric material. Tilt angle is plotted on the vertical axis 1301 and voltage is plotted on the horizontal axis 1303. It is shown that when the mirror tilts up to about eight degrees for a relative permittivity of 1 as shown by reference numeral 1309, for example, the electrostatic force equals the restoring force (e.g., mechanical spring force) at reference numeral 1307 and the operation of tilting the mirror is stable. Beyond eight degrees 1305, the mechanical restoring force dominates the electrostatic force, which causes an unstable condition which is not generally suitable for operating the mirror. The point up to and including reference numeral 1307 is called as the pull-in range. Accordingly, operation of the tilt angle relative to voltage should not go beyond the pull-in range, which is eight degrees in the present example.

As depicted in the Fig., the presence of the dielectric material also reduces the drive voltage significantly, e.g. the pull-in voltage is reduced by 35% from ε₂=1 to ε₂=20. It also reduces the tilt range to some extent at the same time, 15% in this case. We also demonstrated that the pull-in voltage does not vary much for higher values (i.e., 10-20) of permittivity, but does vary (e.g., 10 volts and greater) for lower values of permittivity, i.e., 1-3. These and other models are used to determine particular values for permittivity, thickness, etc. in implementing the present invention. These and other variations, modifications, and alternatives would be recognize by one of ordinary skill in the art.

The above example is merely an illustration, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An integrated circuit and mirror device, the device comprising:
a first substrate comprising a plurality of electrode groups, each of the groups comprising a plurality of electrodes;
a mirror array formed on a second substrate, each of the mirrors on the array having a mirror surface being able to pivot about a point in space, each of the mirrors having a backside surface operably coupled to one of the electrode groups;
a capacitance spacer layer disposed between each of the electrode groups and its respective mirror, the mirror being one from the mirror array; and
a drive circuitry coupled to each electrode groups, the drive circuitry being configured to apply a drive voltage to any one of the electrodes in each of the electrode groups, the drive circuitry being disposed in the first substrate and being adapted to pivot each of the mirror faces about the point in space.

2. The device of claim 1 wherein the mirror array comprises at least an eight by eight array of mirrors.

3. The apparatus of claim 2 wherein the mirror array comprises at least a 100 by 100 array of mirrors.

4. The device of claim 1 further comprising a sense circuit coupled to each of the electrodes.

5. The device of claim 1 further comprising a multiplexing circuit coupled to the drive circuitry.

6. The device of claim 1 further comprising an input/output circuit coupled to each of the electrodes.

7. The device of claim 1 wherein the capacitance layer comprises a selected thickness to reduce the drive voltage by about 10% and less.

8. The device of claim 1 wherein the capacitance layer comprises a dielectric constant.

9. The device of claim 1 wherein the plurality of electrodes are formed on an upper metal layer.

10. The device of claim 9 wherein the upper metal layer further comprising a plurality of bonding pads.

11. The device of claim 9 wherein the capacitance layer comprising openings to expose a portion of each of the bonding pads.

12. The device of claim 11 wherein the capacitance layer is a patterned layer.

13. The device of claim 12 further comprising a shielding layer disposed between the drive circuitry and the plurality of electrodes.

14. The device of claim 13 wherein the shielding layer prevents a portion of electromagnetic noise from coupling between the drive circuitry and the electrodes.

15. The device of claim 14 wherein the shielding layer is made from a material selected from an aluminum bearing material or a titanium bearing material.

16. A method for manufacturing an integrated mirror array and integrated circuit, the method comprising:
forming an integrated circuit device layer on a first substrate;
forming a dielectric layer overlying the integrated circuit device layer;
forming a shielding layer overlying the dielectric layer;
forming a plurality of electrode groups overlying the shielding layer, each of the electrode groups comprising a plurality of electrodes overlying the shielding layer;
forming a capacitance layer overlying the plurality of electrode groups, the capacitance layer being formed at a predetermined thickness to provide a selected capacitance level; and
joining a second substrate comprising the mirror array to the first substrate, each of the mirrors on the array having a mirror surface being able to pivot about a point in space, each of the mirrors having a backside surface operably coupled to one of the electrode groups.

17. The method of claim 16 wherein the shielding layer prevents a portion of electromagnetic noise from coupling between the integrated circuit device layer and the electrodes.

18. The method of claim 16 wherein the capacitance layer comprises a dielectric constant greater than air.

19. An integrated circuit and mirror device, the device comprising:
a first substrate comprising a plurality of electrode groups, each of the groups comprising a plurality of electrodes;
a mirror array formed on a second substrate, each of the mirrors on the array having a mirror surface being able to pivot about a point in space, each of the mirrors having a backside surface operably coupled to one of the electrode groups;
a capacitance spacer layer disposed between each of the electrode groups and its respective mirror, the mirror being one from the mirror array;
a drive circuitry coupled to each electrode groups, the drive circuitry being configured to apply a drive voltage to any one of the electrodes in each of the electrode groups, the drive circuitry being disposed in the first substrate and being adapted to pivot each of the mirror faces about the point in space; and
a shielding layer disposed between the drive circuitry and electrode groups, the shielding layer preventing a possibility of electromagnetic noise from coupling between the drive circuitry and the electrode groups.

20. The device of claim 19 wherein the shielding layer is selected from an aluminum layer or a titanium layer.

21. A method for operating an actuation of a movable mirror device, the method comprising:
applying a selected voltage to drive electrode coupled to a mirror device to form an electrostatic force to actuate the mirror device, the mirror device being supported by one or more torsion bars that allows the mirror device to move in annular manner about an axis, the axis being parallel to the one or more torsion bars; and
controlling the selected voltage to the drive electrode where the mirror operates within a pull-in range, the pull-in range being dependent upon a spring constant of the torsion bar, an angular position of the mirror device, a permittivity of at least a medium between the drive electrode and the mirror device, and the selected voltage that is applied to the drive electrode.
